(19) United States
(12) Patent Application Publication
(10) Pub. No.: US 2026/0185897 A1
(43) Pub. Date: Jul. 2, 2026

(54) TESTING DEVICE AND METHODS FOR FLUORESCENCE IMAGING DEVICES

(71) Applicant: KARL STORZ Imaging, Inc.

(72) Inventors: Jonathan Bormet, Goleta, CA (US); Ed Schifferns, Santa Barbara, CA (US)

(73) Assignee: KARLSTORZ Imaging, Inc, Goleta, CA (US)

(21) Appl. No.: 19/414,922

(22) Filed: Dec. 10, 2025

Related U.S. Application Data
(60) Provisional application No. 63/740,457, filed on Dec. 31, 2024.

(51) Int. Cl. G01M 11/02; G01N 21/64

(52) U.S. Cl. CPC G01M 11/0207; G01N 21/6428; G01N 21/6456; G01N 2021/6471; G01N 2021/6495; G01N 2021/6497; G01N 2201/0627

(57) ABSTRACT

An electronic testing device for pre-operative checks of medical scopes such as fluorescence imaging instruments. The testing device includes a light sensor configured to receive excitation light from an excitation light source and a light emitter configured to emit an emission light to be detected by a fluorescence imaging instrument. The testing device may include an optical light excitation filter, aligned with the light sensor, having a discrete excitation wavelength band corresponding to an excitation wavelength of a first fluorophore. The emission light emitted by the light emitter is of an excitation wavelength corresponding to an emission wavelength band of the first fluorophore.

### CROSS-REFERENCE TO RELATED APPLICATION

This application claims priority to U.S. Provisional Application No. 63/740,457, filed Dec. 31, 2024, and entitled “Testing Device and Methods for Fluorescence Imaging Devices,” the contents of which are incorporated herein by reference.

### TECHNICAL FIELD OF THE INVENTION

The disclosure relates generally to methods and testing devices for medical scopes such as fluorescence imaging devices.

### BACKGROUND OF THE INVENTION

Endoscopes and other medical scopes often use fluorescing agents or autofluorescence to better examine tissue. A fluorescing agent such as a dye may be injected or otherwise administered to tissue. Subsequently, an excitation light is directed toward the tissue. Responsive to the excitation light, the fluorescing agent fluoresces (emits light, typically at a longer wavelength than the excitation light), allowing a sensor to detect this emission light. Image data is collected by the sensor, and examining the collected images can indicate the concentration of fluorescing agent in the observed tissue.

Many fluorescence imaging (FI) devices require, or would benefit from, a quality testing, calibration checks, and other pre-operative checks of the imaging capability of the system. This is commonly accomplished using a printed test card containing fluorescent dye. However, the fluorescent dye can degrade over time, leading to incorrect pre-operative checks or the inability to conduct pre-operative checks with the printed test card.

What is needed are test devices and methods that provide improved pre-operative checks without the risk of dye degradation.

### SUMMARY OF THE INVENTION

The present disclosure encompasses devices, systems, and methods that improve upon the conventional printed test card devices containing fluorescent dye used to provide pre-operative checks, the specification alleviates problems associated with fluorescent dye degradation. The present disclosure provides testing devices that do not use fluorescent dye, instead employing, for example, light sensors and light emitters that that mimic the spectral absorption and emission properties of a fluorescent material used in prior printed test cards. The testing devices of this invention are used to test a fluorescence imaging instrument that may later be used in a medical operation.

According to a first aspect of the invention, a testing device is provided for fluorescence imaging instruments. The testing device includes a light sensor that is configured to receive excitation light from an excitation light source. The excitation light source can be the fluorescence imaging device to be tested or can be a separate light source. The testing device also includes a light emitter that is configured to emit an emission light to be detected by the fluorescence imaging instrument being tested. A controller is in communication with the light sensor and light emitter and configured to drive the light emitter to emit the emission light at an intensity level based on an intensity level of light sensed by the light sensor. The testing device also includes an optical light excitation filter optically aligned with the light sensor. The optical light excitation filter has a discrete excitation wavelength band corresponding to an excitation wavelength of a first fluorophore. The emission light emitted by the light emitter is of an excitation wavelength corresponding to an emission wavelength band of the first fluorophore.

As used herein, a fluorophore is a fluorescent chemical compound (a fluorescing agent used in imaging) that can re-emit light upon light excitation. The fluorophore absorbs light energy of a specific wavelength range (or band) and re-emits light in a, generally, longer wavelength range. The absorbed and emission wavelengths depend in part on the structure of a given fluorophore. Different fluorophores have varying emission light wavelengths. A specific fluorophore has a discrete excitation wavelength band and emits light having a discrete excitation wavelength band. In the practice of this invention, a light source will illuminate a testing device with light having a discrete wavelength band for a fluorophore being used in imaging and the light emitter of the testing device will emit light having a wavelength band corresponding to that fluorophore.

One such fluorophore used in modern medical imaging is Cy5.5, which is excited with light in the wavelength range of 660 nm to 690 nm (red; absorption maximum at 675 nm) and emits fluorescent light in the wavelength range of 680 nm to 720 nm (emission maximum at 694 nm or 707 nm). Another commonly used fluorophore is indocyanine green (ICG), which is excited with light in the wavelength range of 700 nm to 850 nm (red to infrared; absorption maximum at 830 nm) and emits fluorescent light in the wavelength range of 780 nm to 870 nm (emission maximum at 830 nm). Additionally, two fluorophores can be used together, allowing dual fluorescence imaging.

According to some embodiments of the first aspect, the light sensor and the light emitter are positioned side-by-side and configured so that the excitation light and the emission light are spatially offset. The testing device can also include a beam splitter which redirects emission light from the light emitter. In some embodiments, the beam splitter is a dichroic beam splitter having a mirror surface positioned to be struck by the emission light. In some embodiments, the light emitter and the beam splitter are arranged such that the appearance of the emission light and the excitation light reflected from the mirror surface are collocated from a viewing perspective.

In addition, the testing device can also include a second light emitter, wherein the controller drives either the first light emitter or the second light emitter to emit emission light that based on the intensity level detected by either the first light sensor or a second light sensor. The apparent location of the emission light is different from a viewing perspective depending on whether the first light emitter or the second light emitter is selectively driven to emit emission light.

The testing device can include a second optical light excitation filter aligned with a second light sensor. The second optical light excitation filter has a discrete excitation wavelength band corresponding to an excitation wavelength of a second fluorophore wherein the second optical light excitation filter has a different spectral band as compared to the first optical light excitation filter. That is, the second optical light excitation filter is selected to match a second fluorophore having different absorption and/or emission characteristics as compared to the first fluorophore.

In one embodiment, the second light sensor and the first light sensor are positioned side-by-side and configured so that the excitation light and the emission light are spatially offset. In this regard, the second optical light excitation filter has a discrete excitation wavelength band corresponding to an excitation wavelength of a second fluorophore. The emission light emitted by the second light emitter is of an excitation wavelength corresponding to an emission wavelength band of the second fluorophore. In this embodiment, the testing device also includes a beam splitter configured to direct excitation light toward the first optical light excitation filter and the second optical light excitation filter, wherein different types of excitation light stimulate only one of either the first light sensor or the second light sensor due to the different spectral bands of the first optical light excitation filter and the second optical light excitation filter.

In some embodiments, the testing device includes a dispersive prism or diffraction grating which receives excitation light and emission light from the light emitter wherein the light sensor and light emitter are spatially offset within the testing device while the emission light and excitation light appear collocated at an upper surface of the testing device.

In some embodiments, a light sensor is a cadmium-sulfide cell or a photodiode.

In some embodiments, the light sensor(s) and the light emitter(s) are mounted along a housing with the controller mounted in the housing.

In some embodiments, the controller is coupled to sensing circuitry that is coupled to the light sensor. The controller can be coupled to driving circuitry coupled to a light emitter.

In some embodiments, the excitation light source is part of the fluorescence imaging instrument.

According to a second aspect of the invention, a system is provided for testing a fluorescence imaging instrument. The system includes a testing device which comprises a light sensor configured to receive excitation light from an excitation light source; a light emitter configured to emit emission light to be detected by the fluorescence imaging instrument; and a controller in communication with the light sensor and light emitter. In this broad respect, the controller is configured to drive the light emitter to emit light at an intensity level based on an intensity level of light sensed by the light sensor. The testing device includes an optical light excitation filter optically aligned with the light sensor wherein the optical light excitation filter has a discrete excitation wavelength band corresponding to the excitation wavelength of a first fluorophore. In this broad aspect of the invention, the emission light emitted by the light emitter is of an excitation wavelength corresponding to an emission wavelength band of the first fluorophore. The system includes a fluorescence imaging instrument and a camera control unit adapted for coupling to the fluorescence imaging instrument. In this embodiment, the testing device and the camera control unit are configured to communicate with each other.

According to a third aspect of the invention, a method includes illuminating a testing device having a light sensor with excitation light from an excitation light source wherein the excitation light passes through an optical light excitation filter before contacting the light sensor. The method includes measuring an intensity level of the excitation light incident on the light sensor and driving a light emitter to emit light at an intensity level based on an intensity level of light sensed by the light sensor toward a fluorescence imaging instrument. The method further includes evaluating the appearance of the emission light.

These and other features of the invention will be apparent from the following description of the preferred embodiments, considered along with the accompanying drawings.

### BRIEF DESCRIPTION OF THE DRAWINGS

The present disclosure will become more fully understood from the detailed description given herein and the accompanying drawings which are given by way of illustration only and thus are not limitative.

FIG. 1 shows a side view of a medical scope according to some embodiments of the disclosure;

FIG. 2 shows a diagram illustrating a representative testing device in optical alignment with a fluorescence imaging medical scope according to other embodiments of the disclosure;

FIG. 3 shows a diagram illustrating another representative testing device in optical alignment with a fluorescence imaging medical scope according to some embodiments of the disclosure;

FIG. 4 shows a cross section of another representative embodiment of a testing device according to some embodiments of the disclosure;

FIG. 5 shows the top view of the testing device of FIG. 4;

FIG. 6 is a representative hardware block diagram of a fluorescence imaging medical scope according to some embodiments of the disclosure;

FIGS. 7A-7D show cross sections of representative testing device configurations and views of the respective visual patterns associated with the configurations according to some embodiments of the disclosure;

FIG. 8 shows a diagram illustrating another testing device configuration aligned with a fluorescence imaging medical scope according to some embodiments of the disclosure; and

FIG. 9 shows another representative testing device configuration and a diagram of the visual patterns associated with the configuration according to some embodiments of the disclosure.

### DETAILED DESCRIPTION OF EXAMPLE EMBODIMENTS

As used herein, first elements (e.g., sensors and lenses) that are “optically arranged” in relation to other elements, refers to the first elements'position along a common optical path that includes first and other elements. For example, a lens group optically arranged between an image sensor and an objective, means that the lens group occupies a portion of the optical path that light travels (e.g., from the objective to the image sensor) for capturing images or video.

Because digital cameras, visible light imaging sensors, FI sensors and related circuitry for signal capture and processing are well-known, the present description will be directed in particular to elements forming part of, or cooperating more directly with, a method and apparatus in accordance with the invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

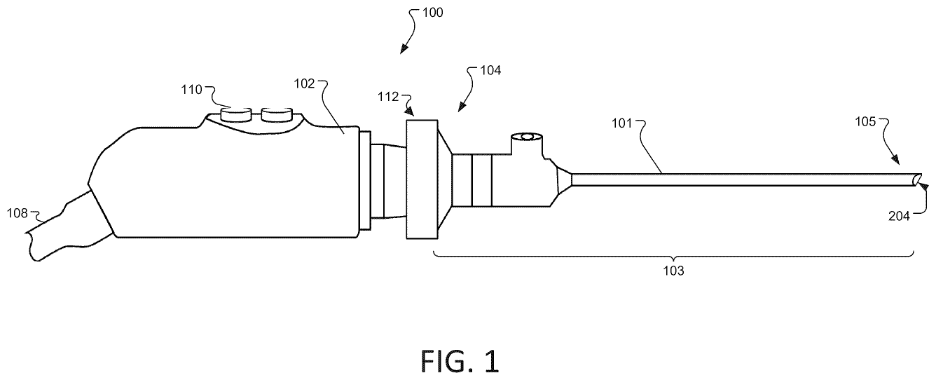

FIG. 1 shows a side perspective view of a fluorescence imaging medical scope 100 and generally shows a scope element 103 including an elongated shaft 101, the scope element being connected to a camera head 102. In this embodiment, scope 103 can be detachably connected to the camera head 102 by any means known in the art, such as a bayonet connector 112, or the elements may be parts of a single instrument 100. In other embodiments, the camera head and scope shaft are merged into a single assembly. It should also be noted that, in some embodiments, an endoscope need not be attached to the camera head at all, the camera head being configured to process fluorescent light images independent of any attached endoscope. Shaft 101 extends from a proximal end shown generally at reference numeral 104 connected to camera head 102 to a distal end generally indicated at reference numeral 105. An objective lens 204, often a wide angle lens, is located at the distal end 105 and may be positioned behind a viewing window. The rigid, elongated shaft 101 generally includes a relay lens system, such as a series of coupled rod lenses, to transmit an image collected by the objective lens 204 to the proximal 104 portion of the scope 103. The image is then received by the camera head 102. The shown shaft 101 is a rigid implementation, but flexible-shaft implementations are also possible.

While this embodiment includes the image sensor in camera head 102, other embodiments may include the image sensors and associated optics in the distal end 105.

Camera head 102 receives electrical operating power through a cable 108 which extends from a proximal end of camera head 102 in this example instrument. This power may be used to operate one or more light sources or, in some embodiments, such as those with distally placed image sensors, other electronic elements mounted within distal portion 105, including one or more electronic image sensors. Also, when image sensors are distally placed, data signals from such an imaging device may be communicated through appropriate conduits within shaft 101 and handle 102 to cable 108. These data signals may be communicated through cable 108 to processing equipment, such as a camera control unit or CCU (not shown) which processes the image data and drives one or more video monitors to display the images collected by the instrument 100. Those familiar with endoscopes and borescopes will appreciate that instrument 100 includes a number of additional features such as controls 110 for controlling the operation of the instrument. Although data transmission relating to the image sensors will be described further below, the general operation and control of medical scope 100 will not be described further herein in order to avoid obscuring the present invention in unnecessary detail.

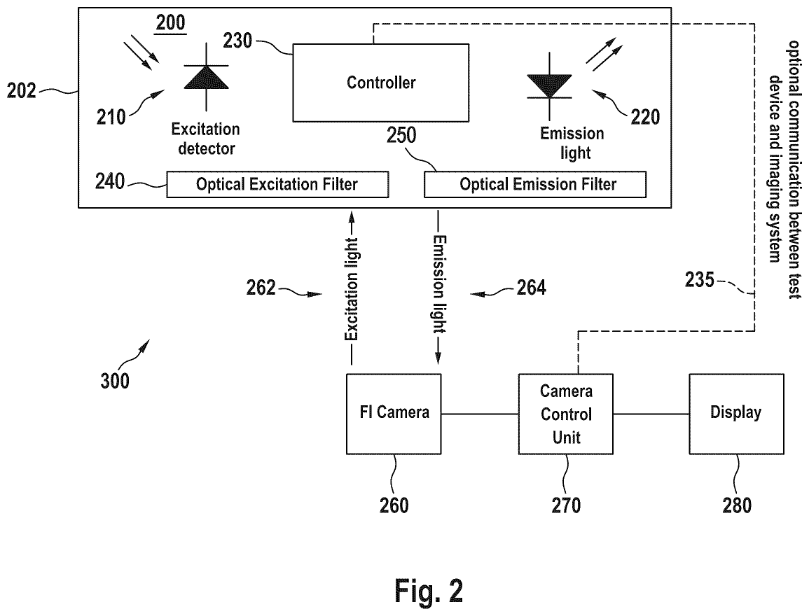

FIG. 2 shows a diagram illustrating a representative testing device 200 in optical alignment with a fluorescence imaging medical scope 100. The testing device 200 includes light sensor 210, which can also be referred to as an excitation detector, and a light emitter 220. The light sensor 210 and light emitter 220 are mounted to or within a housing 202. The light sensor 210 can be, for example, one or more photodiodes or cadmium sulfide cells, or, in some embodiments, an image sensor such as a CCD or CMOS sensor. Excitation light 262 from an excitation light source, such as a fluorescence imaging camera 260, passes through an optical excitation filter 240, with the excitation light 262 then being detected by excitation detector 210. Alternatively, the excitation light 262 can be an excitation light source separate from the FI camera 260. The excitation light source can be any source capable of producing a desired wavelength of excitation light 262 corresponding to the wavelength required to excite a given fluorophore.

The light sensor 210 and light emitter 220 communicatively couple to controller 230 which calculates the amount of excitation light 262 incident on the testing device 200. An optical excitation filter 240 placed over the light sensitive device makes it selectively respond to FI excitation light in like manner to a fluorophore. The sensed excitation light can be mapped to a desired quantity of emission light 264 using an electronic control circuit (e.g. an operation amplifier (op-amp)) or a microcontroller.

The controller 230 drives an emission light source 220 such as an LED to produce comparable intensity to the clinical dye, or another intensity suitable for testing the fluorescence imaging medical device. If desired, an optical emission filter 250 can be used to further refine the spectral properties of the emission light 264.

The fluorescence imaging camera 260 of the imaging instrument 100 is connected to and is controlled by camera control unit 270. The camera control unit 270 is connected to and provides input to display 280 for visual display.

Also identified in FIG. 2 is a system 300 composed of the testing device 200 and the fluorescence imaging system composed of the fluorescence camera 260, camera control unit 270, and the display 280. An optional communication link 235 is shown, through which the controller 230 is in communication with camera control unit 270 for performing automatic calibration under control of camera control unit 270. Camera control unit 270 may send commands to controller 230 to emit light at designated wavelengths or intensities. In this alternative configuration, controller 230 of testing device 200 may communicate with the medical imaging device to provide status (such as excitation light detected, insufficient intensity detected, and so on). Optionally the imaging device may report detection of the emission light. Optionally the imaging device may self-calibrate by configuration of exposure gains and the like based on its measured response to the fluorescence testing device. In one embodiment, the testing device may be integrated directly into the camera control unit, for example, within the front panel of the device. Such a configuration would enable self-test by the camera system.

In one embodiment, the testing device may communicate with the medical imaging device to provide status (i.e. excitation light detected, or insufficient intensity detected, etc.). Optionally, the imaging device may report detection of the emission light. Optionally, the imaging device may calibrate itself by configuration of exposure gains and the like based on its measured response to the FI test device. The test device may be integrated directly into the camera control unit, for example within the front panel of the device. Such a configuration would enable self-test by the camera system.

In one embodiment, a fluorescence imaging camera 260 in FI mode targets the testing device 200. Excitation light 262 incident on the testing device 200 is measured by the controller 230 and used to determine how much emission light to return to the fluorescence imaging camera 260. The appearance of the test target may be evaluated subjectively on display 280 as is commonly done with test cards containing fluorescent dye. Alternatively, electronic communication between the testing device 200 and the camera system can be used to enable reporting performance status on the display 280 screen. Electronic communication may additionally enable calibrating the camera or tuning the pipeline.

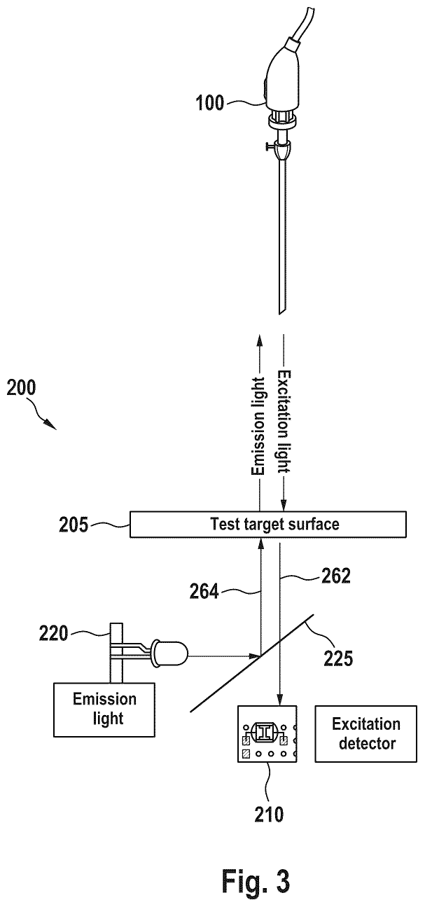

FIG. 3 shows a diagram illustrating another representative testing device in optical alignment with a fluorescence imaging medical scope 100. The testing device 200 in FIG. 3 includes a test target surface 205 through which excitation light 262 is directed. In the embodiment of FIG. 3, a beam splitter 225, such as a dichroic mirror or similar optical splitter, permits excitation light 262 to pass through to the light sensor 210. A controller (not shown in FIG. 3) analyzes the detected excitation light 262 and drives the light emitter 220 to emit emission light 264 toward the mirror face and out through the test target surface 205. In this embodiment, the light sensor 210 (which can be referred to as an excitation detector) and emission light 264 can be co-located as they would be on fluorescing target. Otherwise, the light sensor 210 and light emitter 220 would be somewhat offset on the surface of the target 205.

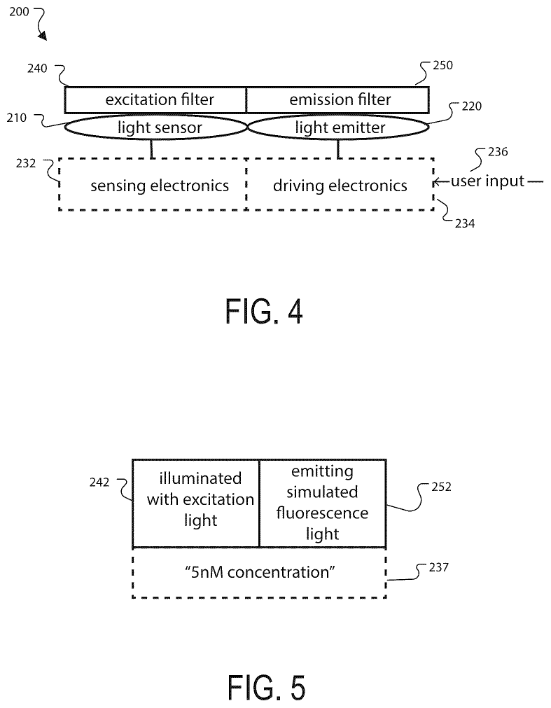

FIG. 4 shows a side view, cross section of another representative embodiment of a testing device 200 in which the light sensor 210 and light emitter 220 are spatially offset. In FIG. 4, the illumination receiving area with the light sensor 210 is positioned below an excitation filter 240. The light emitter 220 is spatially offset with respect to the light sensor 210. In addition, in this embodiment, the light emitter 200 is positioned below an optical emission filter 250. In this embodiment, the sensing electronics 232 and driving electronics 234 are underneath the light sensor 210 and light emitter 220. Optionally, user input 236 can be input to determine a fluorescence concentration to mimic a particular concentration by adjusting the proportion of emission light 264 to excitation light 262.

FIG. 5 shows the top view of the test device 200 shown in FIG. 4. In FIG. 5, the light absorption area 242 corresponds to the area occupied by light sensor 210. The light absorption area 242 is illuminated with excitation light 262 from a light source such as a fluorescence imaging device. The light emission area 252 corresponds to the area occupied by light emitter 220. Because the light sensor 210 and light emitter 220 are positioned side-by-side (offset spatially), the light emission area 252 and the light absorption area 242 are also positioned side-by-side, offset spatially. Dotted line 237 represents a given fluorescence concentration 237, for example 5 nM concentration, provided by user input 236. The testing device 200 may be preconfigured to mimic a particular concentration or, alternatively, may be input by a user via buttons, dials, and so on (not shown) that adjust the configuration.

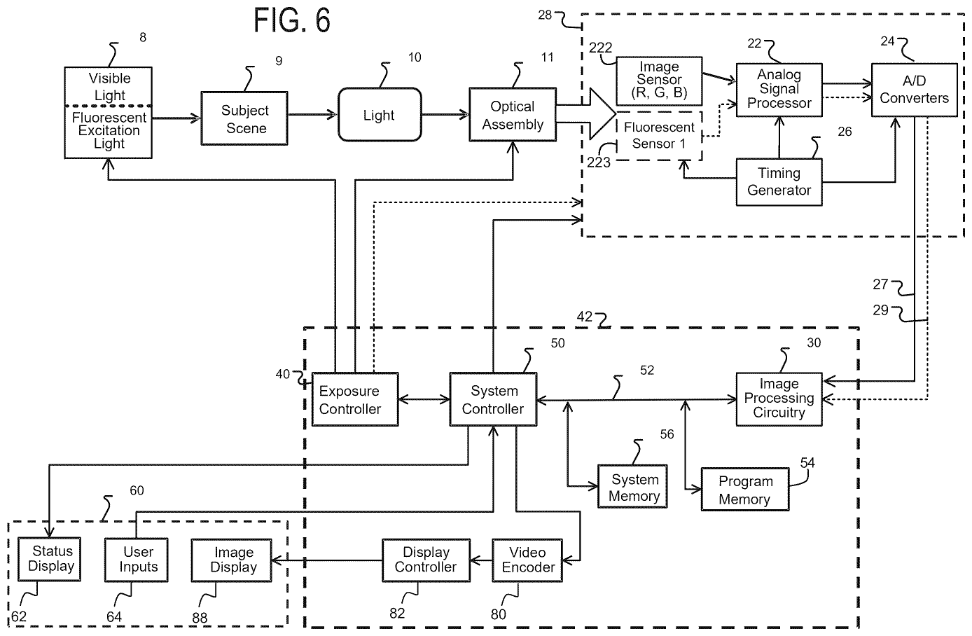

FIG. 6 shows a block diagram of system including an image capture device and an endoscope device. The invention is applicable to more than one type of device enabled for image capture, such as FI-capable endoscopes, other FI medical imaging devices. The preferred version is an imaging scope system, such as an endoscope.

As shown in the diagram of an endoscope device system, a light source 8 illuminates subject scene 9 with visible light and/or fluorescent excitation light, which may be outside the visible spectrum in the ultra-violet range or the infra-red/near infrared range, or both. Light source 8 may include a single light emitting element configured to provide light throughout the desired spectrum, or a visible light emitting element and a one or more fluorescent excitation light emitting elements. Further, light source 8 may include fiber optics passing through the body of the scope, or other light emitting arrangements such as LEDs or laser diodes positioned at or near the front of the scope.

As shown in the drawing, light 10 reflected from (or, alternatively, as in the case of fluorescence, excitation light 8 absorbed and subsequently emitted by) the subject scene is input to an optical assembly 11, where the light is focused to form an image at a solid-state image sensor(s) 222 and/or fluoresced light sensor(s) 223.

Optical assembly 11 may include an optical relay system. An additional lens group may be included at the camera head. Portions of the optical assembly may be embodied in a camera head, while other portions are in an endoscope or other scope device, or the optical assembly 11 may be contained in a single imaging device. Image sensor 222 (which may include separate R, G, and B sensor arrays) and fluoresced light sensor 223 convert the incident visible and invisible light to an electrical signal by integrating charge for each picture element (pixel). It is noted that fluoresced light sensor 223 is shown as an optional dotted box because embodiments may use the RGB image sensor 222 to detect only white light images or to also detect fluoresced light (e.g., NIR, ICG, FI). The latter scheme may be used when the fluoresced light is in a spectrum detectable by image sensor 222 that is in or near the visible light spectrum typically detected by a RGB sensor arrays.

The image sensor 222 and fluoresced light sensor 223 may be active pixel complementary metal oxide semiconductor sensor (CMOS APS) or a charge-coupled device (CCD).

The total amount of light 10 reaching the image sensor 222 and/or fluoresced light sensor 223 is regulated by the light source 8 intensity, the optical assembly 11 aperture, and the time for which the image sensor 222 and fluoresced light sensor 223 integrates charge. An exposure controller 40 responds to the amount of light available in the scene given the intensity and spatial distribution of digitized signals corresponding to the intensity and spatial distribution of the light focused on image sensor 222 and fluoresced light sensor 223.

Exposure controller 40 also controls the transmission of fluorescent excitation light from light source 8 and may control the visible and fluorescent light emitting elements to be on at the same time, or to alternate to allow fluoresced light frames to be captured in the absence of visible light if such is required by the fluorescent imaging scheme employed. Exposure controller 40 may also control the optical assembly 11 aperture, and indirectly, the time for which the image sensor 222 and fluoresced light sensor 223 integrate charge. The control connection from exposure controller 40 to timing generator 26 is shown as a dotted line because the control is typically indirect.

Typically, exposure controller 40 has a different timing and exposure scheme for each of sensors 222 and 223. Due to the different types of sensed data, the exposure controller 40 may control the integration time of the sensors 222 and 223 by integrating sensor 222 up to the maximum allowed within a fixed 60 Hz or 50 Hz frame rate (standard frame rates for USA versus European video, respectively), while the fluoresced light sensor 223 may be controlled to vary its integration time from a small fraction of sensor 222 frame time to many multiples of sensor 222 frame time. The frame rate of sensor 222 will typically govern the synchronization process such that images frames based on sensor 223 are repeated or interpolated to synchronize in time with the 50 or 60 fps rate of sensor 222.

Analog signals from the image sensor 222 and fluoresced light sensor 223 are processed by analog signal processor 22 and applied to analog-to-digital (A/D) converter 24 for digitizing the analog sensor signals. The digitized signals each representing streams of images or image representations based on the data, are fed to image processor 30 as image signal 27, and first fluorescent light signal 29. For versions in which the image sensor 222 also functions to detect the fluoresced light, fluoresced light data is included in the image signal 27, typically in one or more of the three color channels.

Image processing circuitry 30 includes circuitry performing digital image processing functions to process and filter the received images as is known in the art. Image processing circuitry may include separate, parallel pipelines for processing the visible light image data and the FI image data separately. Such circuitry is known in the art and will not be further described here. Image processing circuitry 30 may also include circuitry for, in a test mode, evaluating the intensity of the simulated fluorescent response provided by a testing device as described herein and imaged through a fluorescence imaging scope such as that described herein.

Image processing circuitry 30 may provide algorithms, known in the art, for combining visible light imagery with FI imagery in a combined image display, and further highlighting or emphasizing the FI imagery for easily distinguishing the presence of fluorescing features in the image.

Timing generator 26 produces various clocking signals to select rows and pixels and synchronizes the operation of image sensor 222 and fluorescent sensor 223, analog signal processor 22, and A/D converter 24. Image sensor assembly 28 includes the image sensor 222 and fluorescent sensor 223, adjustment control 20, the analog signal processor 22, the A/D converter 24, and the timing generator 26. The functional elements of the image sensor assembly 28 can be fabricated as a single integrated circuit as is commonly done with CMOS image sensors or they can be separately-fabricated integrated circuits.

The system controller 50 controls the overall operation of the image capture device based on a software program stored in program memory 54. This memory can also be used to store user setting selections and other data to be preserved when the camera is turned off.

System controller 50 controls the sequence of data capture by directing exposure controller 40 to set the light source 8 intensity, the optical assembly 11 aperture, and controlling various filters in optical assembly 11 and timing that may be necessary to obtain image streams based on the visible light and fluoresced light. In some versions, optical assembly 11 includes an optical filter configured to attenuate excitation light and transmit the fluoresced light. A data bus 52 includes a pathway for address, data, and control signals.

System controller 50 optionally includes an automatic calibration routine that is capable of interacting with testing device 200 to perform automatic calibration of FI cameras as discussed above with respect to FIG. 2.

Processed image data are continuously sent to video encoder 80 to produce a video signal. This signal is processed by display controller 82 and presented on image display 88. This display is typically a liquid crystal display backlit with light-emitting diodes (LED LCD), although other types of displays are used as well. The processed image data can also be stored in system memory 56 or other internal or external memory device.

The user interface 60, including all or any combination of image display 88, user inputs 64, and status display 62, is controlled by a combination of software programs executed on system controller 50. User inputs typically include some combination of typing keyboards, computer pointing devices, buttons, rocker switches, joysticks, rotary dials, or touch screens. The system controller 50 manages the graphical user interface (GUI) presented on one or more of the displays (e.g. on image display 88). In particular, the system controller 50 will typically have a mode toggle user input (typically through a button on the endoscope or camera head itself, but possibly through a GUI interface), and in response transmit commands to adjust image processing circuitry 30 based on predetermined setting stored in system memory. Such settings may include different settings for different models of scopes that may be attached to a camera head or other imaging device containing image sensor assembly 28.

Image processing circuitry 30 is one of three programmable logic devices, processors, or controllers in this embodiment, in addition to a system controller 50 and the exposure controller 40. Image processing circuitry 30, controller 50, exposure controller 40, system and program memories 56 and 54, video encoder 80 and display controller 82 may be housed within camera control unit (CCU) 42.

CCU 42 may be responsible for powering and controlling light source 8, image sensor assembly 28, and/or optical assembly 11. In some versions, a separate front end camera module may perform some of the image processing functions of image processing circuitry 30.

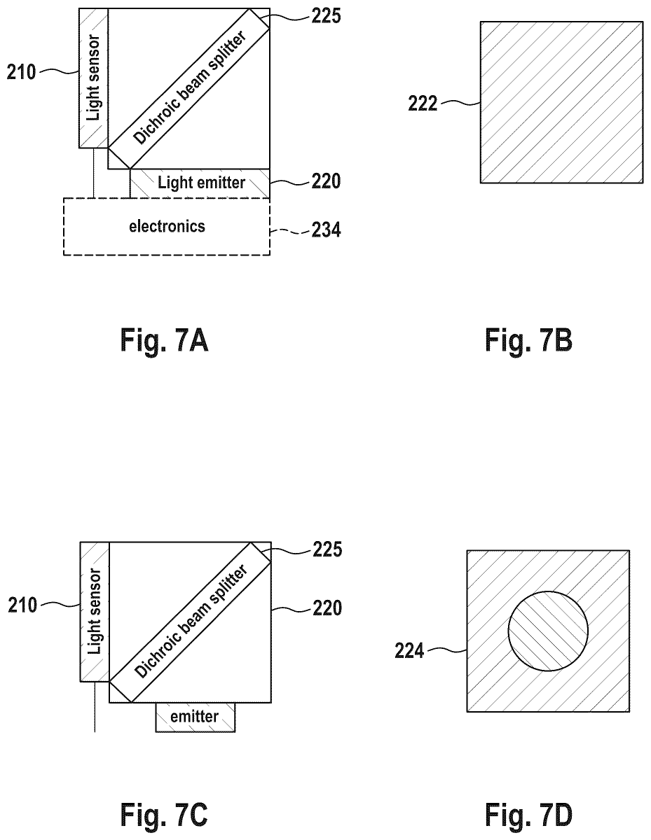

FIGS. 7A-7D show cross sections of representative testing device configurations and views of the respective visual patterns for the configurations according to some embodiments of the invention. In both FIGS. 7A and 7C, the dichroic cube 225 is illuminated from the top, with the dichroic cube 225 directing excitation light to a light sensor 210 which is oriented vertically. Emission light from the light emitter 220 is delivered from the bottom upward to the source of the excitation light. Spectral combination enables collocation of excitation light and emission light.

More particularly, FIG. 7A shows a side view of a testing device with a configuration where the light sensor 210 is positioned vertically and perpendicular to the light emitter 220 with a dichromic beam splitter 225 cube, with the light sensor 210 and the light emitter 220 directly adjacent to different sides of the dichroic beam splitter cube 225. Electronics 234 that are coupled to and in communication with the light sensor 210 and the light emitter 220 are positioned adjacent to the light emitter 220 in this configuration. In one embodiment, excitation light is reflected by the dichroic beam splitter 225 and strikes the light sensor 210, the signal of which is processed and detected by the electronics. Electronics 234 powers the light emitter 220 to emit emission light which passes through the dichroic beam splitter 225 toward the light source (not shown) of the excitation light. The superposition of the reflected excitation light and the emitted light shows either a uniform surface or a region of interest within the illuminated surface. FIG. 7B shows the top view of the superposition of excitation light and emitted light from the testing device in FIG. 7A. Because the size of the areas of the light sensor 210 and the light emitter 220 are the same, the superposition 222 in FIG. 7B is displayed as a uniform surface.

By contrast, in FIG. 7C, the light emitter 220 is smaller, such that the emission light is emitted from a smaller fluorescence region relative to the larger excitation area captured by the light sensor 210. Accordingly, FIG. 7D shows superposition 224 where the appearance of the emission light and reflected excitation light are collocated rather than being offset.

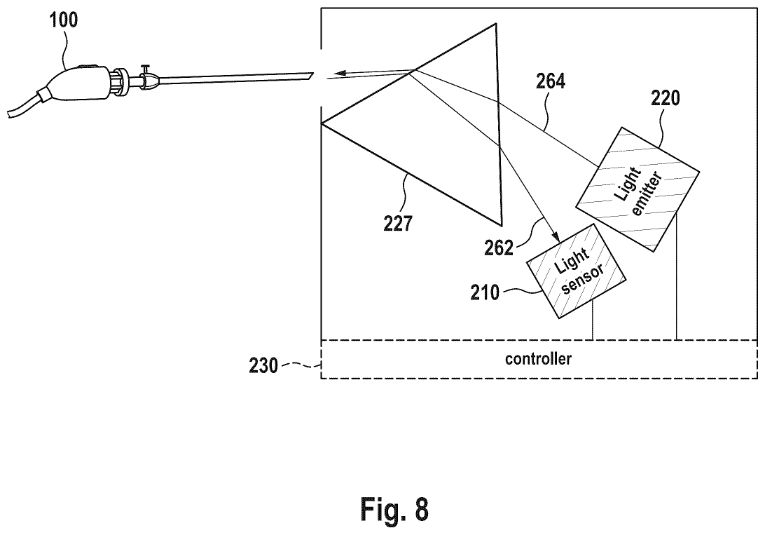

FIG. 8 shows another configuration of a testing device in which a dispersive prism 227 is used in place of the dichroic beam splitter of FIG. 7. In some embodiments, a dispersive prism or diffraction grating can be used in place of the dichroic beam splitter to achieve similar results, which allows spatially offset detection and emission within the testing device to appear collocated at the surface of the test target. In the orientation FIG. 8, a vertical test surface is illuminated from the side. The dispersive prism 227 receives excitation light 262 from a fluorescence imaging device 100 and refracts the excitation light toward a light sensor 210, which is operably connected to a controller 230. The controller 230, which is also operably connected to the light emitter 220, analyzes information from the light sensor 210 and drives the light emitter 220 to project emission light 264. The light emitter 220 is positioned within the testing device 200 so that the emission light 264 from the light emitter 220 strikes the dispersive prism 227 at a position where the dispersive prism 227 directs the emission light 264 directly back to the excitation light source, which in this case is the fluorescence imaging device 100. Thus, while the light sensor 210 and light emitter 220 are spatially offset, the emission light 264 appears collocated with the excitation light 262.

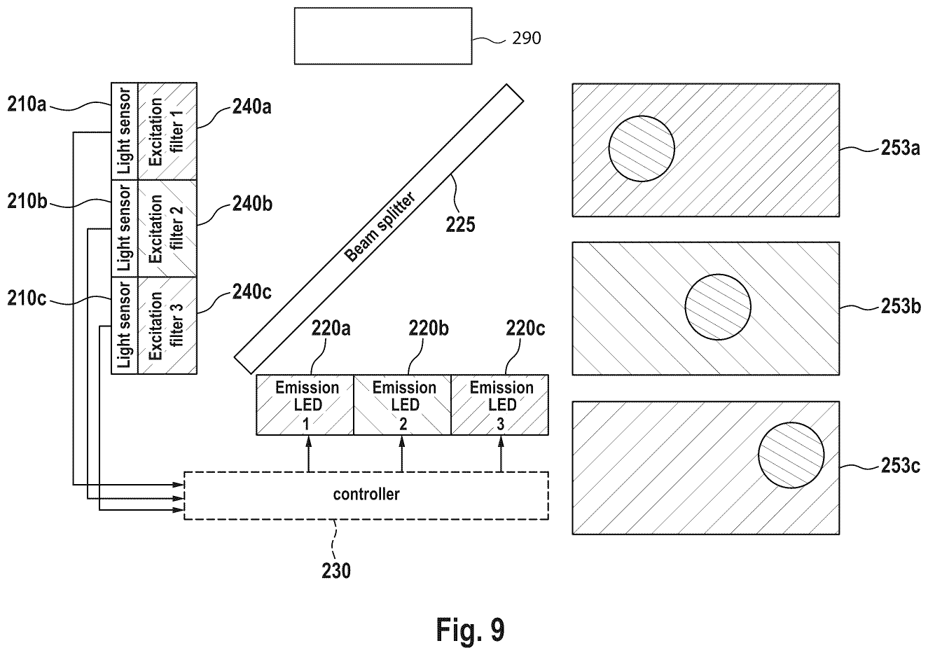

FIG. 9 shows a side cross-sectional diagram of a testing device according to some additional embodiments, along with three superposition views illustrating the effect of the beam splitter as seen from the viewing position. The test device of FIG. 9 includes multiple light sensors and multiple light emitters in combination with a beam splitter. A beam splitter 225 is common to an array of detection elements and an array of emission sources. This configuration permits the testing device to capture multiple excitation light wavelengths corresponding to multiple fluorophores to test different systems, all housed in one testing device. The corresponding emission light is selectively returned by the testing device to mimic the light emitted by a given fluorophore.

In particular, the testing device in FIG. 9 includes three light sensors 210a, 210b, and 210c, which are shown vertically oriented next to the beam splitter 225. Light sensors 210a, 210b, and 210c are positioned behind three respective excitation filters 240a, 240b, and 240c so that each light sensor detects a different excitation light wavelength corresponding to a different fluorophore. Light source 290 provides appropriate wavelength excitation light for a given fluorophore. Different types of excitation light, such as blue in the visible spectrum (visBlue), red in the visible spectrum (visRed), and near infrared (Nir), stimulate a given light sensor due to the excitation filters that permits only a specific wavelength range of light to illuminate specific light sensor or region of a common light sensor. Light sensors 210a, 210b, and 210c are operably coupled to controller 230. Beneath beam splitter 225 are horizontally oriented light emitters (such as LEDs) 220a, 220b, and 220c, which are operably connected to and driven by controller 230. The controller 230 drives an emission band light emitter (such as an LED) that corresponds to which light sensor 210a, 210b, or 210c is stimulated by the specific wavelength of the excitation light. The emission light emitted by the light emitter is of an excitation wavelength corresponding to an emission wavelength band of given fluorophore being mimicked by the light source.

In operation, the optical paths from the viewing direction of box 290 to light sensor 210a and light emitter 220c combine at beamsplitter 225 to produce superposition 253c. This superposition of positions can be viewed, for example, in the display device of a fluorescence imaging system in the viewing position shown at 290. Likewise, light sensor 210b and light emitter 220b produce superposition 253b and light sensor 210c combines with light emitter 220a to yield superposition 253a. For each of suppositions 253a, 253b, and 253c, the apparent location of the fluorescence shifts due to the offset nature of the light emitters (that is, the LEDs in this figure). In addition, the emission light is different from a viewing perspective depending on which light emitter is selectively driven to emit emission light. While three light sensors and three light emitters are depicted in FIG. 9, a testing device of this invention can contain two or more light sensor/excitation filter combinations as well as two or more light emitters that correspond to a given light wavelength that mimic the light emitted by a given fluorophore. It should also be noted that the light sensors 210a, 210b, and 210c can be portions of a single light sensing element, such as a CCD or CMOS image sensor or a uniform array of photodiodes. In such configurations, the known position of the excitation filters 240a, 240b, and 240c will allow the controller 230 to determine the wavelength of light detected by the single light sensing element. A combination of several distinct dichroic beam splitters and common 50-50 beam splitters could be used to produce a similar multi-fluorophore device with collocated excitation and emission areas.

Although this distribution of imaging device functional control among multiple programmable logic devices, processors, and controllers is typical, these programmable logic devices, processors, or controllers can be combinable in various ways without affecting the functional operation of the imaging device and the application of the invention. These programmable logic devices, processors, or controllers can comprise one or more programmable logic devices, digital signal processor devices, microcontrollers, or other digital logic circuits. Although a combination of such programmable logic devices, processors, or controllers has been described, it should be apparent that one programmable logic device, digital signal processor, microcontroller, or other digital logic circuit can be designated to perform all of the needed functions. All of these variations can perform the same function and fall within the scope of this invention.

As used herein the terms “comprising,” “including,” “carrying,” “having” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The foregoing has outlined rather broadly the features and technical advantages of the invention in order that the detailed description of the invention that follows may be better understood. It should be appreciated by those skilled in the art that the conception and specific embodiments disclosed may be readily utilized as a basis for modifying or designing other structures for carrying out the same purposes of the invention. It should also be realized by those skilled in the art that such equivalent constructions do not depart from the scope of the invention as set forth in the appended claims.

Although the invention and its advantages have been described in detail, it should be understood that various changes, substitutions and alterations can be made herein without departing from the scope of the invention as defined by the appended claims. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

Moreover, the scope of the present application is not intended to be limited to the particular embodiments of the process, machine, manufacture, composition of matter, means, methods and steps described in the specification. As one of ordinary skill in the art will readily appreciate from the disclosure of the invention, processes, machines, manufacture, compositions of matter, means, methods, or steps, presently existing or later to be developed that perform substantially the same function or achieve substantially the same result as the corresponding embodiments described herein may be utilized according to the invention. Accordingly, the appended claims are intended to include within their scope such processes, machines, manufacture, compositions of matter, means, methods, or steps.

1. A testing device for fluorescence imaging instruments, comprising:
a light sensor configured to receive excitation light from an excitation light source;
a light emitter configured to emit an emission light to be detected by a fluorescence imaging instrument;
a controller in communication with the light sensor and light emitter, wherein the controller is configured to drive the light emitter to emit the emission light at an intensity level based on an intensity level of light sensed by the light sensor; and
an optical light excitation filter aligned with the light sensor wherein the optical light excitation filter has a discrete excitation wavelength band corresponding to an excitation wavelength of a first fluorophore,
wherein the emission light emitted by the light emitter is of an excitation wavelength corresponding to an emission wavelength band of the first fluorophore.

2. The testing device (200) according to claim 1, wherein the light sensor and the light emitter are positioned side-by-side and configured so that the excitation light and the emission light are spatially offset.

3. The testing device according to claim 1, further comprising a beam splitter which redirects emission light from the light emitter.

4. The testing device according to claim 3, wherein the beam splitter is a dichroic beam splitter having a mirror surface positioned to be struck by the emission light, and wherein the light emitter and beam splitter are arranged such that the appearance of the emission light and the excitation light reflected from the mirror surface are collocated from a viewing perspective.

5. The testing device according to claim 3, further comprising a second light emitter, wherein the controller drives either light emitter or second light emitter to emit emission light that based on the intensity level detected by either light sensor or a second light sensor, wherein the apparent location of the emission light is different, from a viewing perspective, depending on whether light emitter or second light emitter is selectively driven to emit emission light.

6. The testing device according to claim 1, further comprising:
a second optical light excitation filter aligned with a second light sensor wherein the second optical light excitation filter has a different spectral band as compared to the optical light excitation filter, wherein the second light sensor and the light sensor are positioned side-by-side and configured so that the excitation light and the emission light are spatially offset; and
a beam splitter configured to direct excitation light toward the optical light excitation filter and the second optical light excitation filter, wherein different types of excitation light stimulate only one of the light sensor or second light sensor due to the different spectral bands of the optical light excitation filter and the second optical light excitation filter.

7. The testing device according to claim 1, further comprising a dispersive prism or diffraction grating which receives excitation light and emission light from the light emitter wherein the light sensor and light emitter are spatially offset within the testing device while the emission light and excitation light appear collocated at an upper surface of the testing device.

8. The testing device according to claim 1, wherein the controller is coupled to sensing circuitry that is coupled to the light sensor, and wherein the controller is coupled to driving circuitry coupled to the light emitter.

9. A system for testing a fluorescence imaging instrument, comprising:
a testing device which comprises a light sensor configured to receive excitation light from an excitation light source; a light emitter configured to emit emission light to be detected by the fluorescence imaging instrument; a controller in communication with the light sensor and light emitter, wherein the controller is configured to drive the light emitter to emit light at an intensity level based on an intensity level of light sensed by the light sensor; an optical light excitation filter aligned with the light sensor wherein the optical light excitation filter has a discrete excitation wavelength band corresponding to the excitation wavelength of a first fluorophore; wherein the emission light emitted by the light emitter is of an excitation wavelength corresponding to an emission wavelength band of the first fluorophore;
a fluorescence imaging instrument; and
a camera control unit adapted for coupling to the fluorescence imaging instrument,
wherein the testing device and the camera control unit are configured to communicate with each other.

10. The system according to claim 9, wherein the light sensor and the light emitter are positioned side-by-side and configured so that the excitation light and the emission light are spatially offset.

11. The system according to claim 9, further comprising a beam splitter through which travels emission light from the light emitter.

12. The system according to claim 11, wherein the beam splitter is a dichroic beam splitter cube having a mirror surface positioned to be struck by the emission light, and wherein the light emitter and the beam splitter are positioned such that the appearance of the emission light and excitation light reflected from the mirror surface are collocated.

13. The system according to claim 9, wherein the light sensor and the light emitter are mounted along a housing, and the controller is mounted in the housing.

14. The system according to claim 9, further comprising:
a second optical light excitation filter aligned with a second light sensor wherein the second optical light excitation filter has a different spectral band as compared to the optical light excitation filter, wherein the second light sensor and light sensor are positioned side-by-side and configured so that the excitation light and the emission light are spatially offset; and
a beam splitter configured to direct excitation light toward the optical light excitation filter and the second optical light excitation filter, wherein different types of excitation light stimulate only one of the light sensor or second light sensor due to the different spectral bands of the optical light excitation filter and the second optical light excitation filter.

15. The system according to claim 14, further comprising a second light emitter, wherein the controller drives either light emitter or second light emitter to emit emission light that corresponds to light sensor or second light sensor, wherein the apparent location of the emission light is different from a viewing perspective depending on whether light emitter or second light emitter is selectively driven to emit emission light.

16. The system according to claim 9, wherein the controller is coupled sensing circuitry coupled to the light sensor and wherein the controller is coupled to driving circuitry coupled to the light emitter.

17. The system according to claim 9, further comprising a dispersive prism or diffraction grating which receives excitation light and emission light from the light emitter wherein the light sensor and light emitter are spatially offset within the testing device while the emission light and excitation light appear collocated at an upper surface of the testing device.

18. A method comprising:
illuminating a testing device having a light sensor with excitation light from an excitation light source wherein the excitation light passes through an optical light excitation filter before contacting the light sensor;
measuring an intensity level of the excitation light incident on the light sensor;
driving a light emitter to emit light at an intensity level based on an intensity level of light sensed by the light sensor toward a fluorescence imaging instrument; and
evaluating appearance of the emission light.

19. The method according to claim 18, further comprising attaching the testing device to a camera control unit and powering the testing device from the camera control unit.

20. The method according to claim 22, further comprising inputting a fluorescence concentration value into the test device.
